(19) United States
(12) Patent Application Publication
(10) Pub. No.: US 2025/0334556 A1
(43) Pub. Date: Oct. 30, 2025

(54) INDUSTRIAL SCALE ENDOTHERMIC PILOT PLANT SYSTEM

(71) Applicant: Saudi Arabian Oil Company, Dhahran (SA)

(72) Inventors: Omer Refa KOSEOGLU, Dhahran (SA); Anas Farkad ALKHANI, Dhahran (SA)

(73) Assignee: Saudi Arabian Oil Company, Dhahran (SA)

(21) Appl. No.: 19/261,329

(22) Filed: Jul. 7, 2025

Related U.S. Application Data
(62) Division of application No. 17/332,484, filed on May 27, 2021, now Pat. No. 12,379,358.

(51) Int. Cl. G01N 31/10; B01J 8/02; B01J 8/18; B01J 8/26

(52) U.S. Cl. CPC G01N 31/10; B01J 8/0285; B01J 8/1836; B01J 8/1872; B01J 8/26; B01J 2208/00973

(57) ABSTRACT

The invention relates to an integrated system for assessing one or more properties of a catalyst. In the system, a chemical reactor or reactors is/are provided, and a bypass is also provided, to transport a sample of whatever is added to the industrial reactor, to the test reactor. Both gases and liquids are transferred to the test reactor. The system also may include regeneration and testing of regenerated catalyst.

### RELATED APPLICATIONS

This application is a divisional of, and claims priority from, U.S. patent application Ser. No. 17/332,484, titled INDUSTRIAL SCALE ENDOTHERMIC PILOT PLANT SYSTEM, filed on May 27, 2021, which is incorporated herein by reference in its entirety.

### FIELD OF THE INVENTION

The invention relates to an apparatus useful in testing properties of a catalyst, as well as processes for using this apparatus for testing a catalyst.

### BACKGROUND

Process conversion plants used in industries such as oil, gas, chemical, and petrochemicals rely on catalysts as essential components of processes designed to yield the maximum amount of a desired product or products while simultaneously optimizing the energy requirements necessary to achieve these aims.

“Catalysts” as used in these fields, generally comprise a catalytically active metal, such as one or more of Co, Mo, Ni, W, Pt and Pd (these are exemplary and not limitative), and a support material, which may be but is not necessarily, such as an amorphous alumina, titania, silica or one of a crystalline zeolite. It is to be understood that by “active metal,” this application means one or more than one, combined, and this is also the case for the components of the support. In brief, a well designed catalyst drives the kinetics of a desired reaction in the desired direction.

The artisan knows that industrial catalysts are available in different states and compositions, across essentially all industries.

The design of catalysts is challenging, and when one is interested in a specific reaction or specific reactions, multiple options are presented. Every user has its own selection criteria for the catalyst(s) used. These include, e.g., the nature of the feedstock, the objective, the desired yield, and so forth.

The factors that are at issue with respect to selection of a catalyst generally require the user to test multiple options before proceeding with the catalyst selected. These testing procedures are expensive and require a great deal of time.

Turning to catalysts and their use in the petrochemical industry, the catalysts in question are generally evaluated in pilot plants, over a period of from 2 weeks to 1 year. Some of the performance parameters which are evaluated for each catalyst system are activity, selectivity, and stability. Testing stability of a catalyst requires a longer period of time than the other performance parameters being evaluated and, given limited resources, “bottlenecks” the ability to evaluate further catalysts.

The methods available for overcoming this bottleneck are manageable but at the expense of time and cost. For example, building additional pilot plants is very expensive.

An alternative to building more facilities involves placing a small receptacle (generally referred to as a “basket”), inside a commercial reactor, together with a small amount of the catalyst being tested. The catalyst then acts with whatever feedstock is being treated, in a chosen reaction cycle at chosen conditions. This approach means that one cannot assess the catalyst until after the cycle is completed. Further, assessing the stability by, e.g., determining the remaining activity of the catalyst requires the use of the aforementioned pilot plant.

When all factors are considered, it is not at all unusual for the testing period for a particular catalyst to run for 2-3 years.

The foregoing details the current state of the art with respect to catalyst testing. In short, feedstock is sampled at an operating facility, shipped to a testing facility, and undergoes several months of testing. Alternatively, “basket utilization” requires 2-3 years of testing. Both approaches are lengthy, and expensive.

U.S. Pat. No. 8,361,798 to Ducreux, et al., which is incorporated by reference, teaches a methodology, referred to as “grafting” in the disclosure, because a catalyst testing device is “grafted” onto an industrial installation. The disclosure features a two phase system in which the feedstock must be liquid and the catalyst must be solid. The configuration of the test system does not allow for testing of vapor phase components. The ability to test a catalyst with a vaporous feedstock is critical, especially in systems which use endothermic reaction systems, where the reactor effluents must be heated between the reactors.

Additional prior art related to the invention includes U.S. Pat. No. 9,943,819 to Sedhu, et al., which utilizes basket type technology of the type discussed above, but does not integrate a test system with an industrial reactor system.

U.S. Pat. No. 8,502,004 to Butler, et al., describes the type of system discussed supra, involving pilot plants. Such systems, as will be understood by the skilled artisan, can only approximate actual working conditions. Additional prior art documents which may be of interest include U.S. Pat. No. 6,869,800 to Torgenson, et al.; U.S. Pat. No. 6,497,844 and its French counterpart FR 2777805 to Bacaud, et al.; published U.S. Patent Application No. U.S. 2008/0014127 to Ogawa, et al.; published U.S. Patent Application No. U.S. 2006/0148089 and its International Application counterpart, WO 2006/083437, International Application WO 2007/104290; WO 1998/07026, and its Canadian counterpart CA 2 263 212 and Petrov, “Problems and Challenges about Accelerated Testing of the Catalytic Activity of Catalysts” in Principles & Methods for Accelerated Catalyst Design and Testing. All of the references cited herein are incorporated by reference.

None of these documents teach or suggest the invention, which is elaborated upon in the disclosure which follows.

### SUMMARY OF THE DISCLOSURE

The invention is an apparatus and method for assessing catalysts. The invention affords the artisan the opportunity to test the catalyst under completely real time conditions. A test unit which can assess a catalyst in operation on a vaporous feedstock, is installed adjacent to a commercial reactor system, and receives a sample of the vaporous feedstock which is identical to the one used in the commercial reactor, under the identical conditions of the reaction. While the invention might be viewed as a “mini pilot plant,” this is not completely accurate, as a pilot plant can approximate, but cannot duplicate, the conditions of a commercial reactor system. The invention permits vast reductions in the amount of time necessary to assess a catalyst resulting in, e.g., vast reductions in the cost of this aspect of the petroleum refining industry.

In one embodiment of the invention, the test unit is configured so that individual test reactors can be depressurized and isolated, which allows the user to replace one or more of the catalysts in any of the test reactors, as frequently as is necessary or desirable.

### BRIEF DESCRIPTION OF THE FIGURES

FIG. 1 shows a schematic diagram of an embodiment of the endothermic pilot plant system according to the invention connected to a catalytic reforming unit with continuous catalyst regeneration and continuous catalyst feeding;

FIG. 2 shows the embodiment of FIG. 1 with three test reactors;

FIG. 3 shows another embodiment of the system according to the invention;

FIG. 4 shows another embodiment of the system according to the invention configured for testing regenerated catalyst; and

FIG. 5 shows another embodiment of the system according to the invention configured for testing regenerated catalyst.

### DETAILED DESCRIPTION OF PREFERRED EMBODIMENTS

FIG. 1 shows an embodiment of the pilot plant system according to the invention including a test unit 200 connected to a commercial endothermic reforming system 100. In FIG. 1, the commercial endothermic reforming system 100 is a known catalytic reforming system for reforming a naphtha feed. Briefly, fresh naphtha feed 1 is supplied from feed tank 101 and mixed with hydrogen 12. The hydrocarbon/hydrogen mixture 2 passes through feedstock/reformate exchanger 102 and is then successively subjected to catalytic treatment in serially connected reactors 104, 106, 108. Prior to entering each reactor 104, 106, 108, the feed is heated in respective furnaces 103, 105, 107 to form a vapor or is heated to reaction temperature. Thus, the hydrocarbon/hydrogen mixture enters the reactors and contacts the catalyst in vapor form or at reaction temperature. From reactor 108, the effluent 9 is then conducted through feedstock/reformate exchanger 102, and the heat exchanged effluent 10 is separated into liquid reformate 11 and hydrogen 12/13 in separator 110. A portion 12 of the hydrogen is then used for mixing with fresh feedstock 1.

It is well known that, in the petrochemical industries, various types of reactors, such as fixed bed, ebulliated bed, continuous stirred bed reactors, slurry bed reactors, moving bed reactors, and combinations of these. The reactors may be as fixed bed or moving bed configuration. In the embodiment shown in FIG. 1, the reactors are moving bed reactors, and the catalyst is successively fed through reactors 104, 106 and 108 and is regenerated in catalyst regenerator 109. The regenerated catalyst stream 20 is then recycled back to reactor 104.

With continued reference to FIG. 1, the test unit 200 includes at least one test reactor 60 containing a catalyst to be tested. The reactor 60 is connected to the commercial system 100 via a conduit 144, for receiving vaporous hydrocarbon mix, or the reactants heated to the reaction temperature, from the commercial system 100. The conduit 144 can be connected to the commercial system 100 downstream of any one of the furnaces 103, 105, 107. In the embodiment shown in FIG. 1, the test reactor 60 receives reactants from the commercial system 100 downstream of furnace 103. As a result, the catalyst present in the test reactor receives the identical feed under identical conditions as reactor 104 of the commercial system 100.

As the hydrocarbon feed passes through the reactors 104, 106, 108 of the commercial system 100, its composition and properties change. For example, the product of feed 6 is different from the product of feed 8. To evaluate the performance of the catalyst to be tested on hydrocarbon of feed 6 or 8 of the commercial system 100, the test reactor 60 can be connected to the commercial system 100 downstream of furnace 105 or 107 via the conduit to receive a portion of feed 6 or 8. Following reaction in the test reactor 60, the products of stream 47 are then analyzed to determine the efficacy of the catalyst of interest. In an embodiment, the products of stream 47 are first separated using a gas liquid separator and the resulting liquid and/or gas are then analyzed. In further embodiments, such a gas/liquid separator can be provided downstream of any or all of the test reactors.

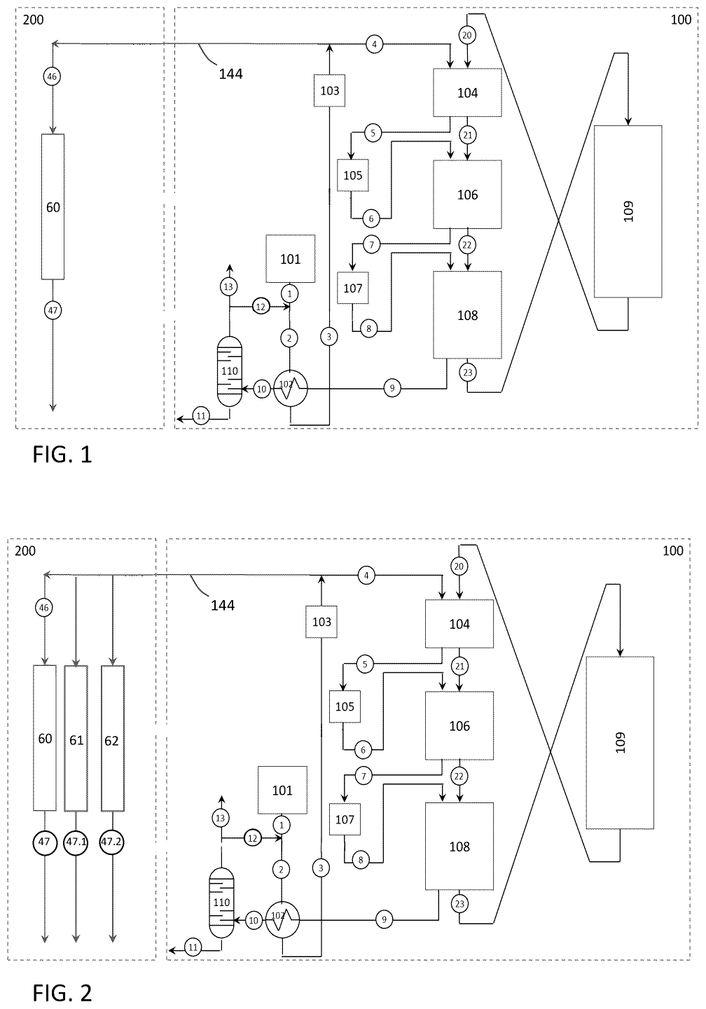

In another embodiment, the test unit 200 can include more than one test reactors. FIG. 2 shows an embodiment in which the test unit 200 includes 3 test reactors 60, 61, 63 connected to the commercial system 100 via conduit 144. This allows simultaneous testing of different catalysts of interest with the same feed under the same conditions. The products of streams 47, 47.1 and 47.2 are then analyzed to determine the efficacy of the different catalysts of interest.

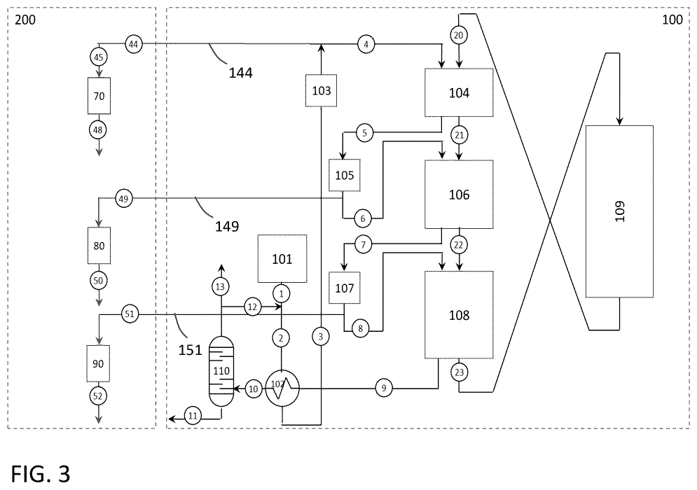

FIG. 3 shows a further embodiment in which the test unit 200 includes 3 test reactors 70, 80, 90. Each of the test reactors 70, 80, 90 is connected to a different point of the commercial system 100 via respective separate conduits 144, 149, 151. This allows simultaneous testing of a catalyst under different conditions encountered during processing of the hydrocarbon feed in the commercial reactor 100.

Combinations of the embodiments shown in FIGS. 2 and 3 are also possible. For example, the embodiment shown in FIG. 3 can be modified so that the test unit 200 includes additional test reactors connected to the commercial system 100 via conduits 144, 149, 151 so that any or all of the conduits 144, 149, 151 deliver hydrocarbon feed from the commercial system 100 to more than one test reactor, similar to the conduit 144 shown in FIG. 2 which delivers the same feed to reactors 60, 61, 62.

In another, embodiment, any or all of the test reactors of the test unit 200 according to the invention can contain more than one catalyst. For example, the test reactors may contain two catalysts arranged in the reactor so as to come into contact with the vaporous feed received from the commercial system 100 via the respective conduits.

It should be noted that the number of reactors and catalysts being evaluated may vary, and is a matter left to the skilled artisan to choose.

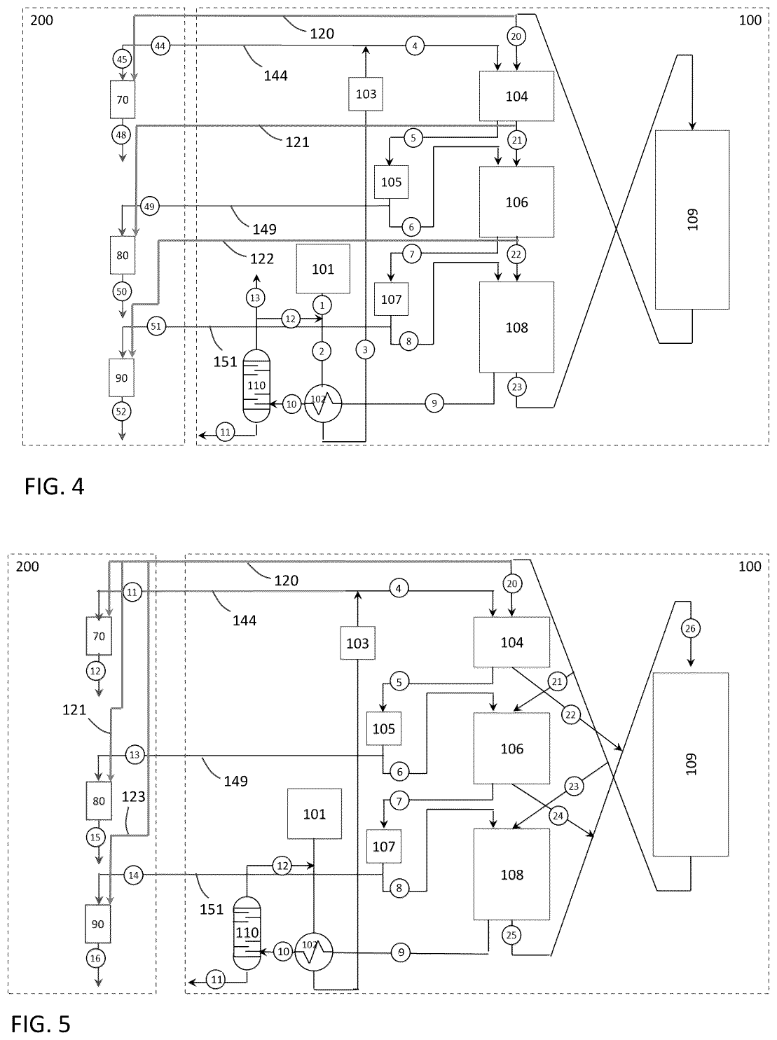

FIG. 4 shows another embodiment of the pilot system similar to the embodiment of FIG. 3. The embodiment of FIG. 4 differs from FIG. 3 in that conduits 120, 121, 149 are additionally present for conducting a catalyst-containing feed from various points of the commercial system 100 to the reactor(s) of the test unit 200. It is known that the efficacy of regeneration of catalysts in regenerators varies depending on the catalyst at hand. This embodiment enables testing the performance of regenerated catalyst that has passed through the commercial system 100 and the catalyst regenerator.

In the embodiment shown in FIG. 4, a portion of the catalyst passes from reactor 104 to reactor 106 and then to reactor 108. The embodiment of FIG. 4 allows withdrawing and testing regenerated catalyst from a catalyst-containing feed 20 directly downstream of the catalyst regenerator 109 via conduit 120 to test reactor 70. Likewise, a portion of catalyst containing feed 21 and/or 22 can be withdrawn downstream of reactor 104 and/or reactor 106 to test reactors 80, 90 respectively via respective conduits 121 and 122.

FIG. 5 shows an embodiment of the pilot system similar to that of FIG. 4, which differs with respect to the flow of catalyst between the reactors of the commercial system 100 and the catalyst regenerator 109. As shown in FIG. 5, catalyst is not moved from one reactor to the next but is directly conducted from each reactor to the regenerator 109 and from the regenerator directly back to each individual reactor 104, 106, 108.

The reactor lengths, both chemical and test, can be from 0.5 to 50 meters long, and are preferably from 1 to 5, and preferably 1-3 meters long. A further preferred embodiment has reactors with an ID (internal diameter) ranging from 1 cm to 25 cm, and preferably 1-10 cm.

In other embodiments, the reactor system provides means for recycling gas, such as hydrogen gas, to these quench spaces. Optionally, additional heaters or furnaces can be provided before each test reactor. This helps maintaining the temperature of the hydrocarbon feed introduced into the test reactors equal to the temperature of the hydrocarbon feed introduced into the chemical reactors of the commercial system.

Similarly, in any and all embodiments of the invention, the nature of the catalyst(s) in the test reactors is “open.” In other words, while the catalyst(s) used in the test reactor may be identical to the catalysts of the commercial reactor, they may be similar, or completely different.

Essentially, the nature of the catalyst(s) used in the test reactor is completely open to the artisan's choice. Any of the catalysts described herein may also comprise an inert diluents, such as glass beads or silicon carbide. The skilled artisan also knows that different catalyst configuration are known and used, such as, but not being limited to, fixed bed or moving bed. Further, the catalysts may be deployed in single or multiple layers.

The artisan will recognize that the concepts discussed herein, such as separating liquid and solid feedstocks, require instrumentation and conditions, which are well known. This disclosure does not repeat features that are well known to the skilled artisan.

Optionally, the pilot plant system also has one or more additional inlets for adding materials, such as hydrogen or other gases to the system, so as to more closely parallel the reaction in the commercial reactor.

The conditions which are used in the commercial and test unit are identical. Exemplary, but not limitative of the conditions, are an operating pressure of 50 bars or less, a reaction temperature of from 100-550° C., and LHSV of 0.1-20 h-1, and so forth.

In embodiments, the pilot plant system may include any embodiment of the test unit 200 alone or the test unit 200 and any or all of the components of any of the embodiments of the commercial unit.

Additional potential embodiments include adding grading material to the test reactor, and the catalyst beds can be diluted with, e.g., inert material, so as to enhance catalyst wetting and axial dispersions.

With reference again to the petrochemical arts, the reactors (both commercial and test) can be insulated to minimize heat loss, and the test reactors can be operated either through the commercial reactor cycle, at intervals, or at any time interval desired by the operator.

In operation, additives can be included in the feedstock of the test reactors, so as to simulate products such as, but not being limited to, chloride, hydrogen sulfide and ammonia. Continuing with features of the feedstock, this can be added to the reactors as up-flow or down-flow.

It will also be understood that the test reactors can be adapted to simulate standard conditions of a commercial reactor, such as start-up, shut-down, catalyst activation, catalyst regeneration, and so forth.

The terms and expression which have been employed are used as terms of description and not of limitation, and there is no intention in the use of such terms and expression of excluding any equivalents of the features shown and described or portions thereof, it being recognized that various modifications are possible within the scope of the invention.

We claim:

1. A system for assessing a performance of a catalyst, said system comprising:
a test unit comprising a test reactor and a conduit connecting the test reactor to an endothermic petrochemical processing system;
said endothermic petrochemical processing system comprising a heater for heating a hydrocarbon feed and a chemical reactor receiving the heated hydrocarbon feed;
said test reactor and said chemical reactor each containing a catalyst;
a regenerator for regenerating the catalyst contained in the chemical reactor, a conduit connecting the regenerator and the chemical reactor, and a conduit connecting the regenerator and the test reactor;
said conduit connecting the test reactor to the endothermic petrochemical processing system conducting a portion of the heated hydrocarbon feed to the test reactor;
said conduit connecting the regenerator and the chemical reactor conducting the catalyst for regenerating from the chemical reactor to the regenerator, and conducting a portion of regenerated catalyst from the regenerator to the chemical reactor; and
said conduit connecting the regenerator and the test reactor conducting another portion of regenerated catalyst from the regenerator to the test reactor to replace the catalyst in the test reactor.

2. The system of claim 1, wherein the test unit comprises plural said test reactors.

3. The system of claim 1, wherein the endothermic petrochemical processing system is a naphtha reforming system.

4. The system of claim 1, wherein the heater heats the hydrocarbon feed to form a vapor which is received by the chemical reactor and the test reactor.

5. The system of claim 1, wherein said catalyst contained in the test reactor is identical to the catalyst in the chemical reactor.

6. The system of claim 1, wherein said catalyst contained in the test reactor is different from the catalyst in the chemical reactor.

7. The system of claim 1, wherein said catalyst contained in the test reactor comprises an inert diluents.

8. The system of claim 7, wherein said inert diluents comprises glass beads or silicon carbide.

9. The system of claim 1, wherein said catalyst in the test reactor is in the form of a whole bed.

10. The system of claim 1, wherein said catalyst in the test reactor is positioned in a plurality of layers.

11. The system of claim 1, further comprising a separation chamber downstream of said test reactor.

12. The system of claim 1, wherein said chemical reactor comprises multiple catalyst beds, each of said multiple catalyst beds containing a different catalyst.

13. The system of claim 12, wherein said test reactor comprises multiple catalyst beds, each of said multiple catalyst beds containing a different catalyst, with a number of catalyst beds in said test reactor being equal to a number of catalyst beds in said chemical reactor.

14. The system of claim 12, comprising a plurality of test reactors, each of which contains a catalyst also contained in said chemical reactor, said test reactors positioned and connected so that said mixture contacts each catalyst in order equal to contact in said chemical reactor.

15. The system of claim 1, wherein said chemical reactor and test reactor are fixed bed or moving bed reactors.

16. The system of claim 1, wherein said chemical reactor and said test reactor are 0.5 m-100 m long.

17. The system of claim 1, wherein said chemical reactor and said test reactor have an ID of from 1 cm to 10 cm.

18. The system of claim 17, wherein said chemical reactor and said test reactor are 1 m to 5 m long.

19. A system for assessing a performance of a catalyst, said system comprising:
a test unit comprising a first test reactor and a second test reactor, a conduit connecting the first test reactor to an endothermic petrochemical processing system, and a conduit connecting the second test reactor to the endothermic petrochemical processing system;
said endothermic petrochemical processing system comprising
a first heater for heating a hydrocarbon feed and producing a heated hydrocarbon feed,
a first chemical reactor connected to the first heater and receiving the heated hydrocarbon feed and producing a first chemical reactor effluent,
a second heater connected to the first chemical reactor and receiving the chemical reactor effluent for reheating and producing a reheated effluent, and
a second chemical reactor connected to the second heater and receiving the reheated effluent and producing a second chemical reactor effluent;
a regenerator for regenerating the catalyst contained in the first chemical reactor, a conduit connecting the regenerator and the first chemical reactor, a conduit connecting the regenerator and the first test reactor and a conduit connecting the regenerator and the second test reactor;
said first test reactor, said first chemical reactor, said second test reactor and said second chemical reactor each containing a catalyst;
said conduit connecting the first test reactor to the endothermic petrochemical processing system conducting a portion of the heated hydrocarbon feed from the first heater to the first test reactor;
said conduit connecting the second test reactor to the endothermic petrochemical processing system conducting a portion of the reheated effluent from heated hydrocarbon feed from the second heater to the second test reactor;
said conduit connecting the regenerator and the first chemical reactor conducting the catalyst for regenerating from the first chemical reactor to the regenerator, and conducting a portion of regenerated catalyst from the regenerator to the first chemical reactor;
said conduit connecting the regenerator and the first test reactor conducting another portion of regenerated catalyst from the regenerator to the first test reactor to replace the catalyst in the first test reactor; and
said conduit connecting the regenerator and the second test reactor conducting a further portion of regenerated catalyst from the regenerator to the second test reactor to replace the catalyst in the second test reactor.

20. The system of claim 19, further comprising a separation chamber downstream of said first test reactor and a separation chamber downstream of said second test reactor.
